(19) United States
(12) Patent Application Publication
(10) Pub. No.: US 2026/0259555 A1
(43) Pub. Date: Sep. 3, 2026

(54) INFORMATION PROCESSING APPARATUS, PRODUCTION PLAN PREPARATION METHOD, AND PRODUCTION PLAN PREPARATION PROGRAM

(71) Applicant: Yokogawa Electric Corporation, Tokyo (JP)

(72) Inventors: Tomohiro KURODA, Tokyo (JP); Hironori HAYASHIZAKI, Tokyo (JP); Akari HARA, Tokyo (JP)

(21) Appl. No.: 19/163,507

(22) PCT Filed: Mar. 14, 2024
(86) PCT No.: PCT/JP2024/010008

§ 371 Date: Sep. 9, 2025

(30) Foreign Application Priority Data
Mar. 14, 2023 (JP) 2023-039955

(51) Int. Cl. G05B 19/418

(52) U.S. Cl. CPC G05B 19/41885; G05B 2219/32301; G05B 2219/49092

(57) ABSTRACT

An information processing apparatus 10 includes a first reception unit configured to receive a predicted amount of clean energy supplied, a second reception unit configured to receive a predicted amount of energy used, and a simulation unit configured to execute, on the basis of the predicted amount of clean energy supplied and the predicted amount of energy used, a simulation of optimizing a production plan having, planned therein, a manufacturing time period for each of products to be produced.

### TECHNICAL FIELD

The present invention relates to an information processing apparatus, a production plan preparation method, and a production plan preparation program.

### BACKGROUND ART

The attention drawn to the international initiative, so-called 100% Renewable Energy (RE100), is increasing, this RE100 being aimed at use of renewable energy by corporations for 100% of electric power used in operations of the corporations.

To implement RE maximization, organizations, such as corporations, use electric power all supplied as electric power derived from clean energy, or purchase attribute values separated from electricity after clean energy power generation.

### CITATION LIST

### Patent Literature

PTL 1: Japanese Laid-open Patent Publication No. 2022-151174
PTL 2: Japanese Laid-open Patent Publication No. 2022-092898

### SUMMARY OF INVENTION

### Technical Problem

However, production plans for products are prepared on the basis of facilities, such as manufacturing lines and manufacturing apparatuses, types of the products and quantities to be produced, manufacture orders including requests, such as time limits for delivery, and quantities in stock; efficiency and the time limits for delivery are thus prioritized; and sometimes production plans not prioritizing RE maximization enough are prepared as a result.

An object of the present invention is to prepare a production plan that supports RE maximization.

### Solution to Problem

According to one aspect of embodiments, an information processing apparatus includes: a first reception unit configured to receive a predicted amount of clean energy supplied; a second reception unit configured to receive a predicted amount of energy used; and a simulation unit configured to execute, on the basis of the predicted amount of clean energy supplied and the predicted amount of energy used, a simulation of optimizing a production plan, having planned therein, a manufacturing time period of each of products to be produced.

According to one aspect of embodiments, a production plan preparation method carried out by a computer, includes: receiving a predicted amount of clean energy supplied; receiving a predicted amount of energy used; and executing, on the basis of the predicted amount of clean energy supplied and the predicted amount of energy used, a simulation of optimizing a production plan, having planned therein, a manufacturing time period of each of products to be produced.

According to one aspect of embodiments, a production plan preparation program causes a computer to execute a process including: receiving a predicted amount of clean energy supplied; receiving a predicted amount of energy used; and executing, on the basis of the predicted amount of clean energy supplied and the predicted amount of energy used, a simulation of optimizing a production plan, having planned therein, a manufacturing time period of each of products to be produced.

### Advantageous Effects of Invention

An embodiment enables preparation of a production plan that supports RE maximization.

### BRIEF DESCRIPTION OF DRAWINGS

FIG. 1 is a diagram illustrating an example of a configuration of a production plan preparation system.

FIG. 2 is a flowchart illustrating steps of a data reception process.

FIG. 3 is a schematic diagram illustrating an electric power supply system.

FIG. 4 is a schematic diagram illustrating an example of purchase of a certificate.

FIG. 5 is a flowchart illustrating steps of a simulation process.

FIG. 6 is a flowchart illustrating steps of an RE level calculation process.

FIG. 7 is a flowchart illustrating steps of an RE level calculation process.

FIG. 8 is a diagram illustrating an example of a production plan.

FIG. 9 is a diagram illustrating an example of manufacturing process information.

FIG. 10 is a diagram illustrating an example of display on a user terminal.

FIG. 11 is a diagram illustrating an example of display on the user terminal.

FIG. 12 is a flowchart illustrating steps of a request issuance process.

FIG. 13 is a flowchart illustrating steps of a request generation process.

FIG. 14 is a diagram illustrating an example of a hardware configuration.

### DESCRIPTION OF EMBODIMENTS

Modes (hereinafter, referred to as “embodiments”) for implementing an information processing apparatus, a production plan preparation method, and a production plan preparation program, according to the present application will hereinafter be described by reference to the appended drawings. Each of the embodiments merely illustrates an example or aspect, and the scope of numerical values and functions and scenes of use are not to be limited by such illustration. The embodiments may be combined, as appropriate, so long as no contradictions in their processing are caused by the combination.

### First Embodiment

### Overall Configuration

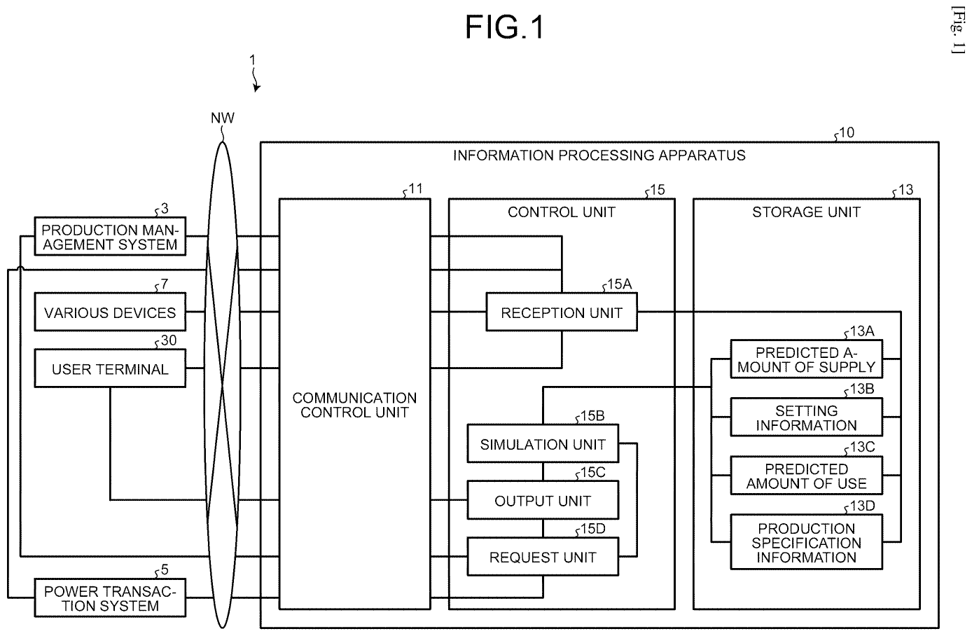

An overall configuration of a production plan preparation system 1 according to an embodiment will be described first. FIG. 1 is a diagram illustrating an example of the configuration of the production plan preparation system 1. The production plan preparation system 1 illustrated in FIG. 1 provides a production plan preparation function of preparing a production plan for a product in a production facility, such as a plant.

The production plan preparation system 1 is differentiated from those of existing conventional techniques in that the production plan preparation system 1 implements, as part of the production plan preparation function, preparation of a production plan that supports RE maximization. “RE maximization” referred to herein means maximizing supply of electric power derived from renewable energy up to a specific target value, and the target value is not necessarily the upper limit value, 100%, and may be 80% or 90%, for example.

“Energy” referred to with respect to the embodiment may include clean energy and non-clean energy. This “clean energy” is also called green energy and may include, for example, so-called renewable energy. Furthermore, “non-clean energy” refers to energy that is not clean energy and may include, for example, fossil energy. Renewable energy will hereinafter be mentioned as an example of clean energy and this renewable energy may hereinafter be referred to as “RE”.

As illustrated in FIG. 1, the production plan preparation system 1 may include a production management system 3, a power transaction system 5, various devices 7, an information processing apparatus 10, and a user terminal 30. The production management system 3, the power transaction system 5, the various devices 7, and the user terminal 30 may be communicably connected to the information processing apparatus 10 via any network NW. The network NW may be wired or wireless and may be implemented by any technology, such as Internet technology, industrial communication standards, or power saving wireless communication standards for Internet of Things (IoT).

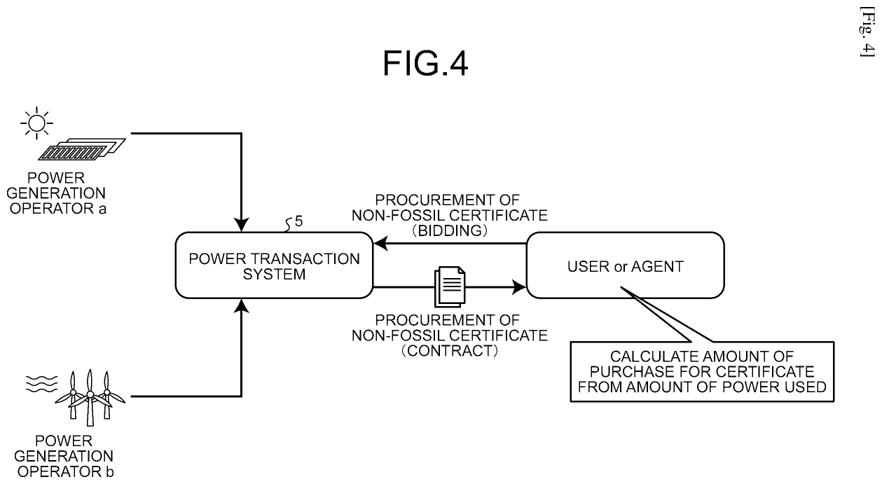

The production management system 3 is a system for collective management of work related to production performed at a production facility, such as a plant, for example. Furthermore, the power transaction system 5 is a system for transactions of environmental values, such as green power certificates, J-Credits, and non-fossil certificates. The power transaction system will be described later by use of FIG. 4.

The various devices 7 are various devices that may be connected to the information processing apparatus 10. For example, the various devices 7 may include a smart meter that measures amounts of power used by a demand facility that a user has, the user being a user who receives provision of the above mentioned production plan preparation function. Such demand facilities may include, in addition to manufacturing lines that are facilities of manufacturing plants and manufacturing apparatuses included in the manufacturing lines, office facilities.

The information processing apparatus 10 is an example of a computer that provides the above mentioned production plan preparation function. For example, the information processing apparatus 10 may be implemented as a server that provides the above mentioned production plan preparation function on premises. The information processing apparatus 10 may also provide the above mentioned production plan preparation function as a cloud service by being implemented as a Platform as a Service (PaaS) application or a Software as a Service (SaaS) application.

The user terminal 30 is a terminal device used by a user who receives provision of the above mentioned production plan preparation function. A “user” referred to herein may be, for example, not only an organization, such as a corporation, but a party concerned with the organization. For example, the user terminal 30 may be implemented by a personal computer, or any computer, such as a smartphone, a tablet device, or a wearable device.

Configuration of Information Processing Apparatus 10 An example of a functional configuration of the information processing apparatus 10 according to the embodiment will be described next. FIG. 1 schematically illustrates blocks related to the production plan preparation function that the information processing apparatus 10 has. As illustrated in FIG. 1, the information processing apparatus 10 has a communication control unit 11, a storage unit 13, and a control unit 15. FIG. 1 just selectively illustrates functional units related to the above mentioned production plan preparation function and the information processing apparatus 10 may thus include any other functional unit not illustrated therein.

The communication control unit 11 is a functional unit that controls communication between: the information processing apparatus 10; and the production management system 3, the power transaction system 5, and the other devices, such as the various devices 7 and the user terminal 30. For example, the communication control unit 11 may be implemented by a network interface card.

The storage unit 13 is a functional unit that stores various types of data. For example, the storage unit 13 may be implemented by an internal, external, or auxiliary storage of the information processing apparatus 10. For example, the storage unit 13 stores data, such as a predicted amount of supply 13A, setting information 13B, a predicted amount of use 13C, and production specification information 13D. The data, such as the predicted amount of supply 13A, the setting information 13B, the predicted amount of use 13C, and the production specification information 13D, will be described when a scene where referencing, generation, or registration is executed is described later.

The control unit 15 is a functional unit that performs overall control of the information processing apparatus 10. For example, the control unit 15 may be implemented by a hardware processor. As illustrated in FIG. 1, the control unit 15 has a reception unit 15A, a simulation unit 15B, an output unit 15C, and a request unit 15D. The control unit 15 may be implemented by, for example, hard wired logic.

The reception unit 15A is a processing unit that receives various types of information. The reception unit 15A corresponds to an example of a first reception unit, a second reception unit, and a third reception unit. In one embodiment, the reception unit 15A receives data, such as a predicted amount of supply, setting information, a predicted amount of use, and production specification information, via the production management system 3, the power transaction system 5, the various devices 7, or the user terminal 30.

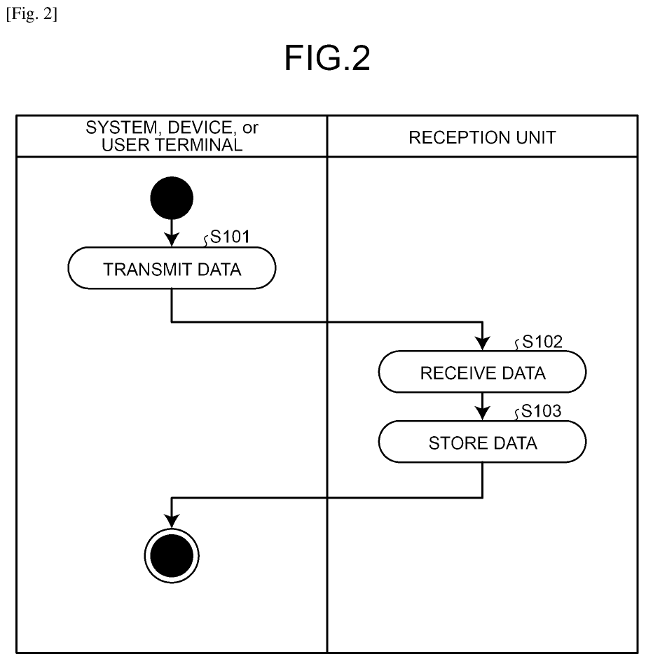

FIG. 2 is a flowchart illustrating steps of a data reception process. As illustrated in FIG. 2, the production management system 3, the power transaction system 5, the various devices 7, or the user terminal 30 transmits/transmit data, such as a predicted amount of supply, setting information, a predicted amount of use, and production specification information (Step S101).

In response to such transmission of the data, the reception unit 15A receives the data, such as the predicted amount of supply, the setting information, the predicted amount of use, and the production specification information, via the network NW (Step S102).

The reception unit 15A then registers the data, such as the predicted amount of supply, the setting information, the predicted amount of use, and the production specification information, as the predicted amount of supply 13A, the setting information 13B, the predicted amount of use 13C, and the production specification information 13D, into the storage unit 13 (Step S103). The predicted amount of supply 13A, the setting information 13B, the predicted amount of use 13C, and the production specification information 13D may be stored in the storage unit 13 as a relational database or in any data format.

In one aspect, at Step S102 described above, the reception unit 15A may receive predicted amounts of energy supplied to a user from a power generator in respective time periods, to implement electric power tracking for a scheduled manufacturing time point, at which a product is to be manufactured according to a production plan.

“Electric power tracking” referred to herein means certifying that electricity consumed by a user is derived from a specific power generation source. However, derivation of a power generation source of electricity flowing in an electric power system (power transmission and distribution network) is assumed to be physically unidentifiable, and physical identification and tracking of the electricity flowing in the electric power system are thus not performed.

According to the basic idea of this tracking, when it can be confirmed that the amount of power generated by a power source connected to an electric power system is equal to the amount consumed by a user facility connected to the same electric power system (electric power is balanced) and that electricity generated by the power source is not consumed by another, the electricity derived from that specific power source is assumed to have been consumed by that specific user.

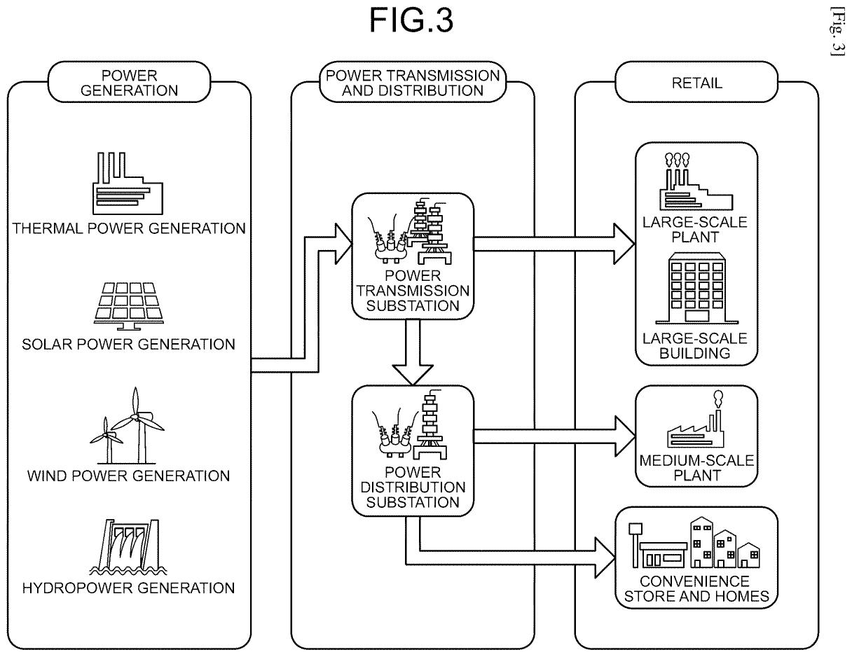

Supply of energy to a user from a power generator may be implemented in the following mode. A “power generator” referred to herein corresponds to an example of a supplier having a power generation facility that generates electric power including clean energy and/or fossil energy. Furthermore, a “user” corresponds to an example of a consumer who has a demand facility that receives and consumes supply of electric power. Such power generators and users may be business operators, such as individuals and corporations, and may also be local and national public organizations. In a first case described herein, a combination of a specific user and a specific power generation source has been defined beforehand. FIG. 3 is a schematic diagram illustrating an electric power supply system. As illustrated in FIG. 3, the electric power supply system may be divided into a power generation sector, a power transmission and distribution sector, and a retail sector. For example, the power generation sector includes thermal power generation serving as a power generation source using fossil energy and power generation sources that use renewable energy, such as solar power generation, wind power generation, and hydropower generation. Furthermore, the power transmission and distribution sector has a power transmission and distribution network formed therein, the power transmission and distribution network connecting users and power generation stations to each other. The power transmission and distribution network may include: a power transmission line that connects a power generation station and a power transmission substation to each other, the power transmission substation being, for example, an extra high-voltage substation, a primary substation, or a secondary substation; and a power distribution line that connects a power distribution substation and a general user to each other. Furthermore, the retail sector may include: a user, such as a large-scale plant or large-scale building that receives supply of special high voltage power; a user, such as a medium-scale plant that receives supply of high voltage power; and a general user that receives supply of low voltage power.

For example, in an example of power balancing in the above mentioned electric power supply system, when solar power generation generates electricity of 1 kWh and a user who has contracted with this solar power generation company consumes electricity of 1 kWh at the same time, it is assumed that “this 1 kWh is the electricity from the solar power generation”. Without being limited to solar power generation, no matter what the type of power generation source the contracted electric power company has is, the same power transmission and distribution line is used for supply of electric power, and matching the electric power company (supplier) and the user (demander) thus achieves power balancing.

In such an electric power supply system, electric power is supplied on the basis of a contract signed between a power generation operator and a user. Therefore, by receiving contract information that is information on a contract signed between a power generation operator and a user organization from the user terminal 30, for example, the reception unit 15A is able to obtain, as a predicted amount of energy supplied to the user organization, an amount of power defined by their contract information. A “predicted amount of supply” referred to herein may be, for example, an average amount of electric power generated in an interval regarded as a standard interval in power balancing, for example, a 30-minute interval. Obtaining a predicted amount of supply for each piece of contract information enables obtainment of predicted amounts of supply in respective time periods for each type of energy of power generation sources that a power generation operator has. For example, without being limited to classifications, such as fossil energy and renewable energy, predicted amounts of supply may be obtained respectively for different types of renewable energy, such as sunlight energy, wind energy, hydro-energy, geothermal energy, solar thermal energy, and biomass energy. Without being limited to automatic extraction from contract information, a predicted amount of energy supplied to a user organization may be input via a graphical user interface (GUI).

In a second case described herein, a certificate representing an attribute value separated from electricity of non-fossil energy after power generation is issued and a determination is made for the first time through purchase of the certificate. Representative examples of the attribute value include an environmental value. Environmental values may include “green power certificates”, “J-Credits”, and “non-fossil certificates”. Among these, a green power certificate is a certificate certifying an “environmental value” by separating the value of electricity from renewable energy into “a value of electricity itself” and the “environmental value”.

FIG. 4 is a schematic diagram illustrating an example of purchase of a certificate. As illustrated in FIG. 4, at the time of bidding for a non-fossil certificate, an amount of purchase (offset) for the non-fossil certificate is calculated from an amount of power used by a user. For example, the offset may be an amount of purchase corresponding to an amount of power lacking for RE100. Upon such determination of an amount of purchase, a bid is made for purchase by a purchaser, such as a user, in the power transaction system 5, the bid specifying a range of frames and an amount of purchase that the user desires to purchase from 48 frames corresponding to one day, with 50 kWh per frame (30 minutes) being the minimum transaction unit. A bid is also made for sale by a seller, such as a power generation operator a or a power generation operator b, in the power transaction system 5, the bid specifying a range of frames and an amount of sale that the power generation operator a or b desires to sell. In such bidding, bids for “sale” and “purchase” are matched and the contracted price and contracted amount are determined by the power transaction system 5, a transaction is thereby implemented, and a non-fossil certificate is procured as a result. An example where a user makes a bid in the power transaction system 5 has been described above, but an agent that performs management of environmental values on behalf of a user may of course make a bid in the power transaction system 5.

For example, in an example supposed herein, the example being an example of power balancing in the above described purchase of a certificate, solar power generation is installed in a plant A and is self-consumed by the plant A. In a case where an environmental value of “no carbon dioxide emission” is unnecessary for the plant A, this environmental value can be sold as a “green power certificate”. In a case where this certificate has been purchased by another plant B, the plant B is assumed to have used renewable energy therein and reduced emission of carbon dioxide.

In such purchase of a certificate, a non-fossil certificate is procured via the power transaction system 5. Therefore, the reception unit 15A receives an amount of purchase for the non-fossil certificate from the power transaction system 5. For example, the power transaction system 5 enables obtainment of an amount of purchase for such a non-fossil certificate, as a predicted amount of renewable energy supplied to a user organization. Predicted amounts of supply can of course be obtained respectively for different types of renewable energy, such as sunlight energy, wind energy, hydro-energy, geothermal energy, solar thermal energy, and biomass energy.

In another aspect, the reception unit 15A may receive setting information on a user from the user terminal at Step S102 described above.

For example, the setting information may include settings for types of energy, CO2 emission factors, and renewable energy factors, for respective power generators. Among these, a “CO2 emission factor” is an index indicating how much CO2 is emitted for supply of electricity of 1 kWh. For example, a CO2 emission factor (kg-CO2/kWh) is calculated by dividing an amount of CO2 emitted by an amount of power sold. Furthermore, a “renewable energy factor” is an index indicating a level, at which energy generated by a power generator corresponds to clean energy. For example, a renewable energy factor may be a value normalized in a numerical range of 0 to 1. In this case, the closer the renewable energy factor is to 1, the closer the energy is to completely clean energy, and the closer the renewable energy factor is to 0, the closer the energy is to pure fossil energy. Such a renewable energy factor may be set collectively or for each time period.

Furthermore, the setting information may include a setting of a degree of priority of an allocated target where energy is to be allocated in electric power tracking. “Allocated targets” referred to herein may include demand facilities grouped in any units, such as units of products, manufacturing processes, manufacturing lines, or manufacturing plants. Allocated targets are not limited to targets related to manufacturing and may include demand facilities included in offices, for example. For example, in an example where the allocated targets are manufacturing lines A to Z, degrees of priority are set for the manufacturing lines A to Z in ascending or descending order of their priority. The setting information may also include settings for degrees of priority among facilities that a user organization has. For example, a first degree of priority may be set for a plant A, a second degree of priority may be set for a plant B, and a third degree of priority may be set for an office. In this case, electric power is allocated according to the order of priority from the plant A, to the plant B, and then to the office. Furthermore, the setting information may include settings of degrees of priority for power generators to be allocated to allocated targets or types of energy generated by a power generator. For example, a first degree of priority may be set for wind power energy, a second degree of priority may be set for sunlight energy, and a third degree of priority may be set for fossil energy. In this case, electric power is allocated according to the order of priority from the wind power energy, to the sunlight energy, and then to the fossil energy. The degrees of priority for the allocated targets, facilities, and types of energy, for example, may be set collectively or for each time period.

The setting information may also include a setting for a power balancing interval. For example, in addition to 30 minutes that is standardly set, any interval, for example, 15 minutes or 60 minutes, may be set as the power balancing interval. Furthermore, the setting information may include, for example, a setting for a product, for which a simulation is executed by the simulation unit 15B described later. Furthermore, the setting information may include a setting for whether input to the production management system 3, for example, input of a production plan, is permitted or prohibited. Furthermore, the setting information may include a setting for whether automatic transaction in the power transaction system 5 is permitted or prohibited. Such settings for the power balancing interval, the target product, the input to the production management system 3, and the automatic transaction in the power transaction system 5 may, for example, be received via the user terminal 30.

In yet another aspect, the reception unit 15A may receive amounts of energy used by a user organization from the various devices 7 for respective time periods at Step S102 described above. For example, the reception unit 15A may receive amounts of electric power used, the amounts having been respectively measured by smart meters connected to demand facilities that the user organization has, the smart meters being an example of the various devices 7. In general, a so-called 30-minute demand value that is an average value of electric power consumed in a 30-minute interval regarded as a standard interval for power balancing is read from a smart meter. A target, for which a reading is to be taken from a smart meter may be any unit in a facility that the user organization has, for example, a unit, such as a product, a manufacturing process, a device that implements a manufacturing line, or the whole plant. An example where amounts of energy used are received from smart meters has been described above, but input of an amount of energy used may be received from the user terminal 30 via a GUI, for example. In this case, the reception unit 15A may cause amounts of energy used in a predetermined time period, for example, one day or one week, to be input collectively.

On the basis of actually measured values for the amounts of use thus received, the reception unit 15A is able to predict amounts of energy used in respective time periods. Such prediction of amounts of use may be implemented by, for example, a machine learning model, such as a neural network, a support vector machine, or a gradient boosting model.

For example, the machine learning model outputs a predicted amount of future use or a data string of predicted amounts of use, when a data string of actually measured values of amounts of use obtained as a past history is input to the machine learning model. Training data for training such a machine learning model are able to be generated from use history data including a data string of actually measured values of amounts of use for a predetermined time period in the past. For example, the use history data are alternately segmented into a segment of a time period corresponding to an input size of the machine learning model, and a subsequent segment of a correct answer label subsequent to that segment. Such segmentation enables obtainment of a data set including sets of training data and their correct answer labels from the use history data. For example, in a training phase, with training data serving as explanatory variables of a machine learning model and labels serving as objective variables of the machine learning model, the machine learning model is able to be trained according to any machine learning algorithm, for example, deep learning. A machine learning model that has been trained is thereby obtained. In a prediction phase, a data string of actually measured values of amounts of use retroactively obtained for a time period corresponding to an input size of the machine learning model from a time point, at which an actually measured value of the latest amount of use is received, is input to the machine learning model that has been trained. The machine learning model that has been trained thereby outputs a predicted amount of use or a data string of predicted amounts of use for a time later than the present time point by a specific time period, the present time point being the time point, at which the measured value of the latest amount of use was obtained.

An example where an actually measured value of an amount of use is obtained and a predict amount of use is predicted from the actually measured value of the amount of use has been described above, but predicted amounts of energy used in respective time periods may be received from the user terminal 30 or an apparatus for predicting amounts of use, the apparatus not being illustrated in the drawings. Furthermore, by using a machine learning model similar to the machine learning model described above, the reception unit 15A may predict a predicted amount of supply from an actually measured value of an amount of supply, similarly to the prediction of a predicted amount of use from an actually measured value of an amount of use.

In another aspect, the reception unit 15A may receive production specification information from the production management system 3 at Step S102 described above. “Production specification information” referred to herein means information on specifications used in preparation of a production plan. For example, to cause a computer to identify a product to be produced and a time limit for delivery thereof, production specification information may include a manufacture order including requests from a client of a user organization, for example, the type and quantity of the product and a time limit for delivery thereof. Furthermore, the production specification information may include the following manufacture master data to cause a computer to identify a method of manufacturing the product to be produced. For example, the manufacture master data may include: information associating each product or manufacturing process with time periods required for operations in units of manufacturing lines or in units of manufacturing apparatuses included in a manufacturing line; and an operation calendar having, set therein, shifts of staff, such as onsite workers and operators. The production specification information may also optionally include: quantities of different products in stock to cause a computer to identify quantities of products to be produced; or renewable energy ratios and amounts of CO2 emission for parts and materials used in their manufacture. An example where production specification information is received from the production management system 3 has been described above, but production specification information may be received from the user terminal 30 via a GUI, for example. In this case, the reception unit 15A may cause production specification information corresponding to a predetermined time period, for example, one day, one week, or one month, to be collectively input.

The simulation unit 15B is a processing unit that executes, on the basis of predicted amounts of clean energy supplied in respective time periods and predicted amounts of energy used in respective time periods, a simulation of optimizing a production plan having, planned therein, manufacturing time periods for respective products to be produced.

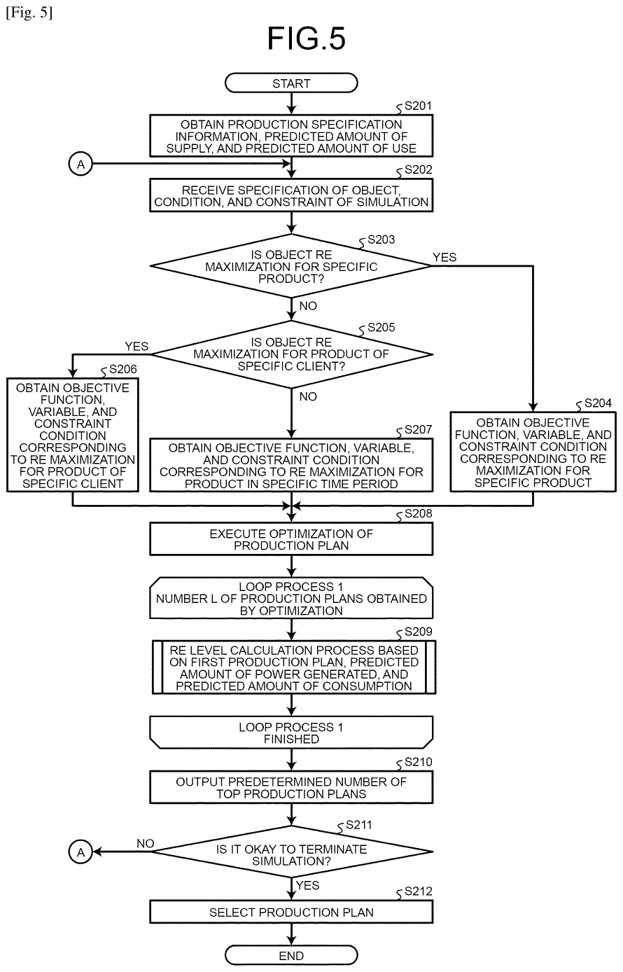

FIG. 5 is a flowchart illustrating steps of a simulation process. As illustrated in FIG. 5, the simulation unit 15B obtains the predicted amount of supply 13A, the predicted amount of use 13C, and the production specification information 13D that have been stored in the storage unit 13 (Step S201).

The simulation unit 15B then receives specification of an object of the simulation (Step S202). Examples of this object include RE maximization for a specific product, RE maximization at a specific client, and RE maximization for a product in a specific time period.

In a case where RE maximization for a specific product has been specified as the object at Step S202 (Yes at Step S203), the simulation unit 15B obtains an objective function, variables, and constraint conditions corresponding to the object (Step S204).

Furthermore, in a case where RE maximization at a specific client has been specified as the object at Step S202 (No at Step S203 and Yes at Step S205), the simulation unit 15B obtains an objective function, variables, and constraint conditions corresponding to the object (Step S206).

Furthermore, in a case where RE maximization for a product in a specific time period has been specified as the object at Step S202 (No at Step S203 and No at Step S205), the simulation unit 15B obtains an objective function, variables, and constraint conditions corresponding to the object (Step S207).

The objective function, variables, and constraint conditions are obtained through the processing of Step S204, Step S206, or Step S207. The simulation unit 15B then executes a simulation of analyzing a production plan optimization problem for maximizing or minimizing the objective function (Step S208).

An example where linear programming is used as an algorithm for analysis of the production plan optimization problem will be described herein. In this case, on the basis of a manufacture order included in production specification information, a product to be produced is set as a variable. Furthermore, on the basis of manufacture master data included in the production specification information, a manufacturing line or a manufacturing apparatus is set as a variable. In addition, as a constraint condition constraining a range, in which a variable is able to be manipulated, a range is formulated as a linear inequality, the range being a range, in which manufacture is completed in compliance with a time limit for delivery and operation is possible without any change in shifts, the manufacture being based on: the manufacture order included in the production specification information; or an operation calendar in the manufacture master data. Furthermore, for each object, an objective function corresponding to the object is formulated by use of variables. For example, a case where a loss function is used as an example of the objective function will be described below as an example. In a case where a loss function having an object of achieving RE maximization for a specific product is to be set, the loss function is formulated by use of the above mentioned variables, and the larger the RE level for the specific product, for example, the difference between the predicted amount of use and the predicted amount of supply, the larger the loss according to the loss function. An example where a difference between a predicted amount of use and a predicted amount of supply is used as an example of a ratio between the predicted amount of use and the predicted amount of supply has been described above, but proportions of the predicted amount of use and predicted amount of supply may be used instead. In a case where a loss function corresponding to an object other than the above mentioned RE maximization for a specific product is to be set, the loss function is able to be set according to similar logic.

Upon formulation of the loss function and constraint conditions, a combination of variables satisfying the constraint conditions and minimizing the loss function is calculated. The combination of variables thus calculated determines a production plan defining manufacturing time periods of respective products to be produced. A loss function has been mentioned above as an example of the objective function, but a combination of variables may be calculated by maximization of a score function formulated by use of variables. Furthermore, without being limited to the linear programming mentioned above, any analytical algorithm may be applied to the production plan optimization problem.

Such a simulation enables preparation of a production plan that supports RE maximization for a product corresponding to an object specified by a user in accordance with the object.

Thereafter, the simulation unit 15B executes a loop process 1 of repeating processing of Step S209 for a number of times corresponding to the number L of production plans satisfying a predetermined condition, for example, production plans having losses equal to or less than a threshold, among production plans obtained as a result of Step S208.

That is, the simulation unit 15B executes an RE level calculation process of calculating, on the basis of a first production plan and the predicted amount of supply and predicted amount of use obtained at Step S201, an RE level for a product produced according to the first production plan (Step S209).

Repetition of this loop process 1 results in calculation of RE levels of respective products for each of L production plans.

Subsequently, the simulation unit 15B outputs a predetermined number of production plans with the top RE levels to, for example, a display unit of the user terminal 30 (Step S210). Until operation to confirm that it is okay to terminate the simulation has been received (No at Step S211), the processing from Step S202 described above to Step S210 described above is repeated.

Thereafter, in a case where operation to confirm that it is okay to terminate the simulation has been received (Yes at Step S211), the simulation unit 15B selects one of the predetermined number of production plans with the top RE levels (Step S212) and ends the process.

At Step S212, the production plan with the highest RE level may be automatically selected or a selection may be manually received from the user terminal 30 via a GUI, for example.

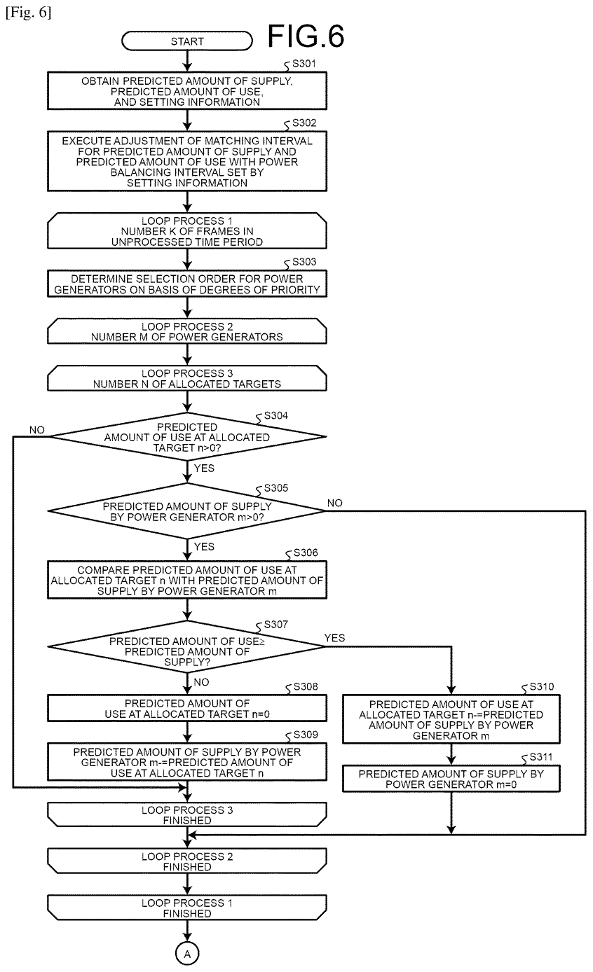

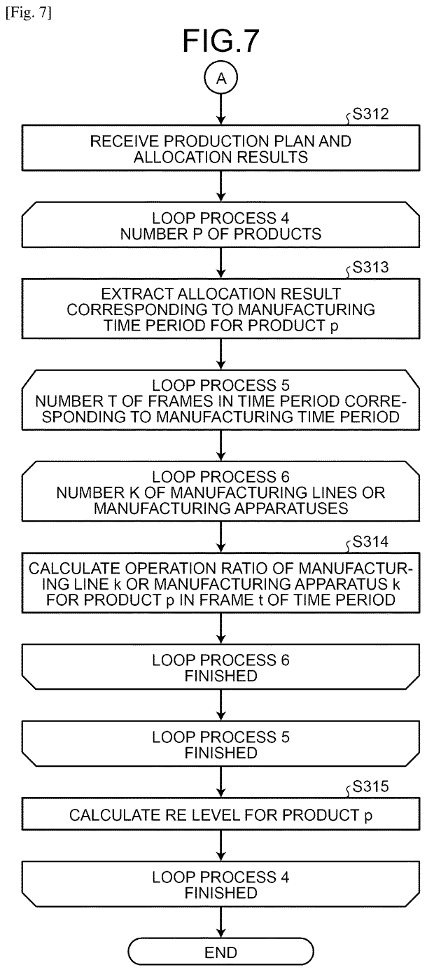

Details of the RE level calculation process illustrated at Step S209 in FIG. 5 will be described next by use of FIG. 6 and FIG. 7. FIG. 6 and FIG. 7 are flowcharts illustrating steps of the RE level calculation process. As illustrated in FIG. 6, the simulation unit 15B obtains the predicted amount of supply 13A, the setting information 13B, and the predicted amount of use 13C that have been stored in the storage unit 13 (Step S301).

Subsequently, the simulation unit 15B executes preprocessing of matching the power balancing interval set in the setting information 13B with the interval for the predicted amount of supply 13A and predicted amount of use 13C (Step S302).

For example, when the interval for the predicted amount of supply 13A and predicted amount of use 13C is 30 minutes and the setting for the power balancing interval is one hour, the paired two predicted amounts of supply are added up together and the paired two predicted amounts of use are added up together. Furthermore, in a case where the measurement interval for the predicted amount of supply 13A and predicted amount of use 13C is 30 minutes and the setting for the power balancing interval is 15 minutes, a predicted amount of supply for 15 minutes and a predicted amount of use for 15 minutes are calculated by dividing each of the predicted amount of supply for 30 minutes and the predicted amount of use for 30 minutes by the ratio of the power balancing interval, for example, 2.

The simulation unit 15B executes a loop process 1 of repeating processing from Step S303 described below to Step S311 described below for a number of times corresponding to the number K of frames in a time period, for which allocation of clean energy has not been processed yet.

That is, on the basis of degrees of priority of power generators set in the setting information 13B, the simulation unit 15B determines the order, in which the power generators are selected, the power generators being sources, from which clean energy is to be allocated (Step S303). For example, in a case where degrees of priority have been set for power generators, the degrees or priority being, for example, a first degree of priority set for a power generator A, a second degree of priority set for a power generator C, and a third degree of priority set for a power generator B, the order, in which they are selected, is determined so that the power generator A, the power generator C, and the power generator B are selected in this order. An example where the order, in which power generators are selected, is determined on the basis of degrees of priority of the power generators has been described above, but the order, in which the power generators are selected, may be determined on the basis of degrees of priority of types of energy generated by the power generators.

The simulation unit 15B then executes a loop process 2 and a loop process 3 of repeating processing from Step S304 described below to Step S311 described below until selection of M power generators is finished or selection of N allocated targets is finished. An “allocated target” referred to herein may be a product, a manufacturing process, a manufacturing line, or a manufacturing apparatus included in a manufacturing process or manufacturing line.

That is, the simulation unit 15B determines whether or not the predicted amount of use at an allocated target n being selected is larger than “0” (Step S304). In a case where the predicted amount of use at the allocated target n is not larger than “0” (No at Step S304), allocation of energy to the allocated target n is found to have finished. In this case, processing from Step S305 to Step S309 is skipped, a loop counter n for allocated targets is incremented, and the next allocated target is selected. The order, in which the allocated targets are selected, is also determined on the basis of degrees of priority of the allocated targets, the degrees of priority having been set in the setting information 13B.

On the contrary, in a case where the predicted amount of use at the allocated target n is larger than “0” (Yes at Step S304), the allocation of energy to the allocated target n is found to have been unfinished. In this case, the simulation unit 15B further determines whether or not the predicted amount of supply by a power generator m being selected is larger than “0” (Step S305).

In a case where the predicted amount of supply by the power generator m is not larger than “0” (No at Step S305), the power generator m is found to have no more remaining electric power to be allocated to the allocated target n. In this case, processing from Step S306 to Step S311 is skipped, a loop counter m for power generators is incremented, and the next power generator is selected.

Furthermore, in a case where the predicted amount of supply by the power generator m is larger than “0” (Yes at Step S305), the power generator m is found to have electric power to spare for allocation to the allocated target n. In this case, the simulation unit 15B compares the predicted amount of use at the allocated target n, with the predicted amount of supply by the power generator m (Step S306).

In a case where the predicted amount of use at the allocated target n is less than the predicted amount of supply by the power generator m (No at Step S307), the remaining predicted amount of supply by the power generator m is found to enable allocation of electric power to the allocated target n to be finished. In this case, the simulation unit 15B updates the predicted amount of use at the allocated target n to “0” (Step S308), and updates the predicted amount of supply by the power generator m to the latest predicted amount by subtracting the predicted amount of use at the allocated target n from the predicted amount of supply by the power generator m (Step S309). Thereafter, the loop counter n for the allocated targets is incremented and the next allocated target is selected.

Repetition of this loop process 3 results in allocation of the power generators or types of energy to the allocated targets in descending order of priority of the allocated targets and the power generators or types of energy are allocated to each of the allocated targets in descending order of priority of the power generators or types of energy.

Furthermore, in a case where the predicted amount of use at the allocated target n is equal to or larger than the predicted amount of supply by the power generator m (Yes at Step S307), allocation of electric power to the allocated target n is found to not finish even if all of the remaining predicted amount of supply by the power generator m is allocated to the allocated target n. In this case, the simulation unit 15B updates the predicted amount of use at the allocated target n to the latest amount by subtracting the predicted amount of supply by the power generator m from the predicted amount of use at the allocated target n (Step S310), and updates the predicted amount of supply by the power generator m to “0” (Step S311). Thereafter, the loop counter m for the power generators is incremented and the next power generator is selected.

Repetition of this loop process 2 results in allocation of energy to the allocated targets in descending order of priority of the power generators or types of energy, and each of the power generators or types of energy is allocated to the allocated targets in descending order of priority of the allocated targets.

Furthermore, repetition of the loop process 1 results in, for each time period, in which allocation of clean energy has not been processed yet: allocation of the power generators or types of energy to the allocated targets in descending order of priority of the allocated targets, the power generators or types of energy being allocated to each of the allocated targets in descending order of priority of the power generators or types of energy; as well as allocation of energy to the allocation targets in descending order of priority of the power generators or types of energy, each of the power generators or types of energy being allocated to the allocated targets in descending order of priority of the allocated targets.

In the example described with respect to the flowchart illustrated in FIG. 6, the renewable energy ratio targeted is RE100 and clean energy is allocated to the allocated target, the clean energy corresponding to the amount of power corresponding one-to-one to the total predicted amount of use at the allocated target n, but the embodiment is not limited to this example. For example, the renewable energy ratio targeted may be any value less than RE100, for example, RE90 or RE80.

Thereafter, as illustrated in FIG. 7, the simulation unit 15B obtains the first production plan and allocation results corresponding to the first production plan (Step S312).

The simulation unit 15B then executes a loop process 4 of repeating processing from Step S313 described below to Step S315 described below for a number of times corresponding to the number P of products included in the first production plan.

That is, the simulation unit 15B refers to a manufacturing time period for a product p being selected from the first production plan and extracts an allocation result for a time period from allocation results, the time period being overlapped by the manufacturing time period for the product p (Step S313).

The simulation unit 15B then executes a loop process 5 of repeating processing of Step S314 described below for a number of times corresponding to the number T of frames in the time period corresponding to the manufacturing time period for the product p. Furthermore, the loop process 5 includes a loop process 6 of repeating the processing of Step S314 described below for a number K of manufacturing lines or manufacturing apparatuses for the product p, the manufacturing lines or manufacturing apparatuses being those that operate in the time period t being selected. That is, the simulation unit 15B calculates an operation ratio of a manufacturing line k for the product p in the time period t or an operation ratio of a manufacturing apparatus k for the product p in the time period t, on the basis of a time period overlapped by the manufacturing time period for the product p, the time period being in the time period t being selected, that is, on the basis of an actual operating time period of the manufacturing line k for the product p or an actual operating time period of the manufacturing apparatus k for the product p (Step S314). For example, an operation ratio is able to be calculated by normalization of an actual operating time period in the time period t to an actual operating time period per unit time. In a calculation example, when the time period t has a frame size of 30 minutes, the unit time is one hour, and the actual operating time period is ten minutes, the actual operating time period per hour is found to be “20 minutes” by calculation of 10 minutes×(60 minutes/30 minutes) and the operation ratio is found to be “1/3” by dividing this “20 minutes” by the unit time.

Repetition of this loop process 6 results in calculation of the operation ratio for each manufacturing line k or manufacturing apparatus k for the product p in the time period t being selected. Furthermore, repetition of the loop process 5 results in calculation of the operation ratio for the manufacturing line k for the product p or operation ratio for the manufacturing apparatus k for the product p, for each time period t overlapped by the manufacturing time period for the product p.

Thereafter, the simulation unit 15B calculates an RE level for the product p (Step S315). For example, in a case where a renewable energy ratio is calculated as an example of the RE level, the simulation unit 15B is able to calculate the renewable energy ratio for the product p according to Equation (1) below. “RE level of manufacturing line k or manufacturing apparatus k in time period t” in Equation (1) below is able to be calculated according to Equation (2) below. In Equation (1) and Equation (2) below, “i” is the number of power generators allocated to the manufacturing line k or manufacturing apparatus k.

$$Renewable energy ratio = \sum ( RE level of manufacturing line k or manufacturing apparatus k in time period t \times operation ratio ) / \sum ( operation ratio ) \qquad ( 1 )$$

$$RE level of manufacturing line k or manufacturing apparatus k in time period t = \sum ( allocated amount it \times renewable energy index i of allocated electric power ) / \sum ( predicted amount kt of use ) \qquad ( 2 )$$

Furthermore, in a case where an amount of CO2 emitted is calculated as an example of the RE level, the simulation unit 15B is able to calculate the amount of CO2 emitted for the product p, according to Equation (3) below. “Amount of CO2 emitted by manufacturing line k or manufacturing apparatus k in time period t” in Equation (3) below is able to be calculated according to Equation (4) below.

$$Amount of CO 2 emitted = \sum ( amount of CO 2 emitted by manufacturing line k or manufacturing apparatus k in time period t \times operation ratio ) + ( amount of CO 2 emitted by material used in manufacturing line k or manufacturing apparatus k ) \qquad ( 3 )$$

$$Amount of CO 2 emitted by manufacturing line k or manufacturing apparatus k in time period t = \sum ( allocated amount it \times CO 2 emission factor i of allocated electric power ) \qquad ( 4 )$$

Repetition of this loop process 4 results in calculation of an RE level for each of P products, for example, a renewable energy ratio or an amount of CO2 emitted. FIG. 7 illustrates an example where RE levels are calculated in units of products, but RE levels may be calculated in units of manufacturing processes, units of manufacturing lines, or units of manufacturing plants.

Results of calculation of RE levels thus calculated in units of products or units of manufacturing processes may be stored in the storage unit 13. The results of the calculation of the RE levels are not necessarily stored in a relational database. For example, the results of the calculation of the RE levels may be recorded in a blockchain network.

Blockchain technology is one of distributed ledger technologies that allow plural nodes of a peer to peer (P2P) network to hold the same database. A group of transactions on a P2P network are collectively processed as a block in a blockchain and blocks are linked to each other by hash functions. Data in a block recorded in a blockchain cannot be altered retroactively unless all of its subsequent blocks are altered and ledger management platforms using blockchains are thus highly secure against alteration.

Any method, such as Proof of Work (PoW) or Proof of Stake (PoS), may be used as a consensus algorithm used between nodes forming such a blockchain network.

An electronic signature using a secret key is assigned to transaction data in a blockchain and impersonation is thereby prevented. A public key cryptosystem is not necessarily used in encryption of the transaction data. For example, any encryption algorithm, such as Advanced Encryption Standard (AES), Secure Hash Algorithm (SHA), Rivest-Shamir-Adleman cryptosystem (RSA), or Elliptic Curve Cryptography (ECC), may be used.

Furthermore, data on each transaction are made public and shared throughout the blockchain network. For some types of P2P databases, the same records are not necessarily held throughout the P2P networks.

Any method, such as Proof of Work (PoW) or Proof of Stake (PoS), may be used as a consensus algorithm used between nodes forming such a blockchain network.

In a case where results of calculation of RE levels are thus recorded in a blockchain network, the simulation unit 15B generates transaction data corresponding to a result of calculation of an RE level in a frame of one time period, transmits a request for registration of the transaction data to the blockchain network, and thereby enables the result of the calculation of the RE level to be recorded in a blockchain.

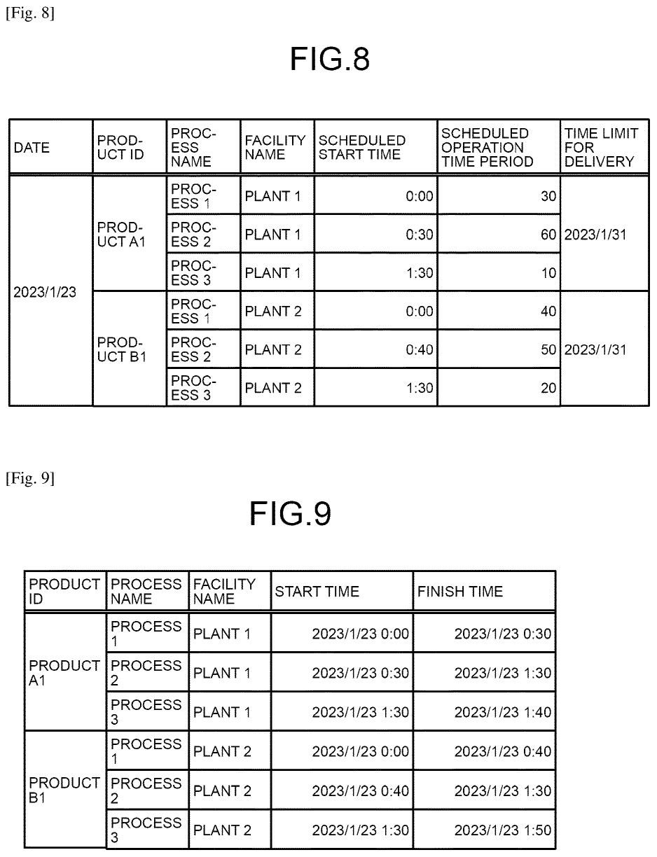

An example of the production plan selected at Step S212 illustrated in FIG. 5 will be described below. FIG. 8 is a diagram illustrating the example of the production plan. FIG. 8 illustrates a production plan for Jan. 23, 2023, but a production plan for any date before or after January 23 may also be included. Furthermore, FIG. 8 selectively illustrates two products, a product A1 and a product B1, in the example of the production plan for Jan. 23, 2023, but of course, other products may also be included. As illustrated in FIG. 8, manufacturing time periods for the respective products to be produced have been planned in the production plan. In the example illustrated in FIG. 8, the manufacturing time periods are defined by start times and required operation time periods for respective processes corresponding to manufacturing processes included therein for each of the product A1 and the product B1. The production plan may include information other than that on the products, the manufacturing processes, the production facilities, and the manufacturing time periods, for example, time limits for delivery to clients for the products in the example illustrated in FIG. 8.

FIG. 9 is a diagram illustrating an example of manufacturing process information. FIG. 9 illustrates manufacturing process information from the production plan illustrated in FIG. 8. As illustrated in FIG. 9, the manufacturing process information also indicates manufacturing time periods respectively for products to be produced. In the example illustrated in FIG. 9, the manufacturing time periods are defined by start times and finish times for respective processes corresponding to manufacturing processes included therein for each of the product A1 and the product B1.

The output unit 15C illustrated in FIG. 1 is a processing unit that outputs various types of information. In one aspect, the output unit 15C is able to output RE levels for different products included in each of production plans to any output destination including the user terminal 30, the production plans having been obtained as results of simulation by the simulation unit 15B. An output destination referred to herein may include: an application or a service executed by a computer of a user organization; or a computer of a third party other than the user organization, for example, a client for a product, or an application or a service executed by that computer.

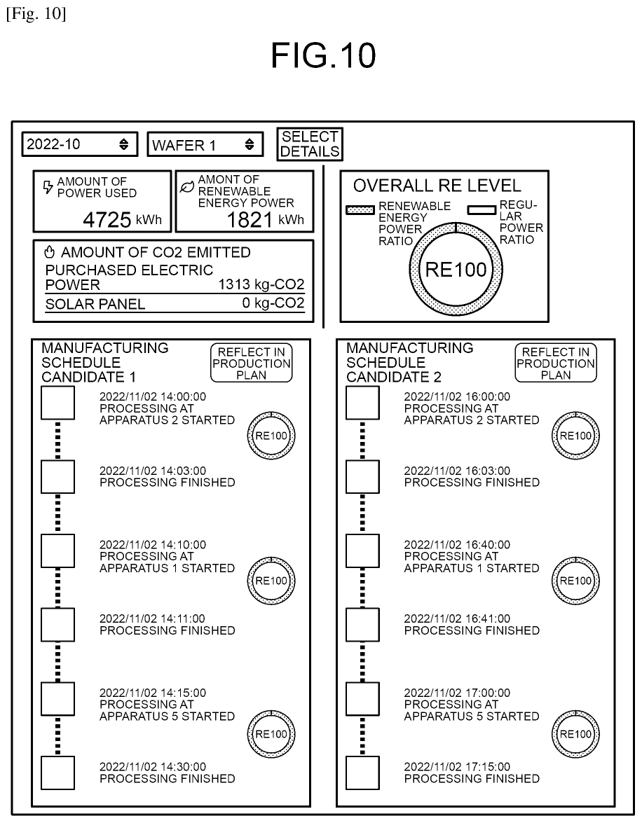

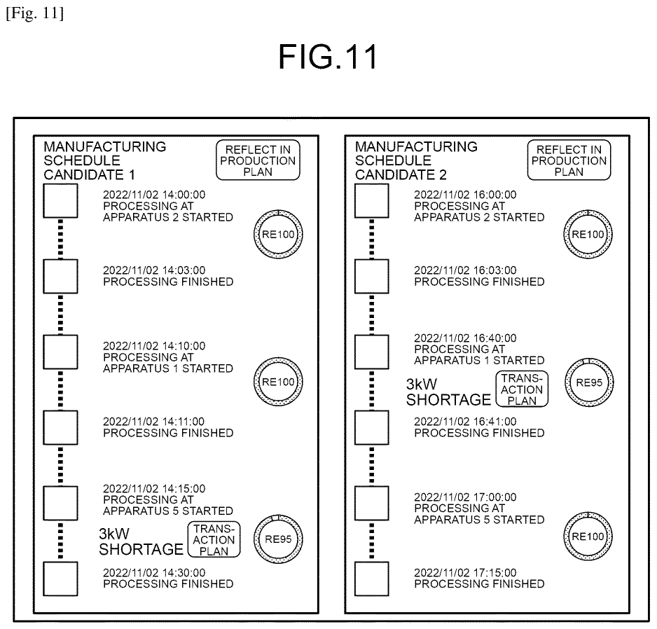

FIG. 10 and FIG. 11 are diagrams illustrating an example of display on the user terminal 30. FIG. 10 and FIG. 11 illustrate a GUI screen displayed at the user terminal 30 at Step S210 illustrated in FIG. 5. Furthermore, FIG. 10 and FIG. 11 illustrate a product, “wafer 1”, an example of a product that has been specified as the specific product at Step S202 illustrated in FIG. 5, among products to be produced. Furthermore, FIG. 10 and FIG. 11 illustrate, as candidates for manufacturing time periods for the product to be produced, “wafer 1”: a manufacturing schedule 1 corresponding to one of two production plans with the top two RE levels; and a manufacturing schedule 2 corresponding to the other one of these two production plans.

Among FIG. 10 and FIG. 11, an example where a manufacturing process that does not achieve RE100 is not included in manufacturing processes for the product to be produced, “wafer 1”, is illustrated in FIG. 10. Such display enables a person in charge of or responsible for production plans at a user organization to know that RE100 is able to be achieved for the product to be produced, “wafer 1”, whether the manufacturing schedule 1 or the manufacturing schedule 2 is adopted.

On the contrary, FIG. 11 illustrates an example where a manufacturing process that does not achieve RE100 is included in manufacturing processes for the product to be produced, “wafer 1”. Such display enables a person in charge of or responsible for production plans at a user organization to know that it is difficult to achieve RE100 for the product to be produced, “wafer 1”, whether the manufacturing schedule 1 is adopted or the manufacturing schedule 2 corresponding to the other production plan is adopted. In the example in FIG. 11, the person is able to know that with the manufacturing schedule 1, electric power from clean energy will become insufficient in processing to be started at 14:15:00 on Nov. 2, 2022, at an apparatus 5. Furthermore, the person is able to know that with the manufacturing schedule 2, electric power from clean energy will become insufficient in processing to be started at 16:40:00 on Nov. 2, 2022, at an apparatus 1. In addition, the person is able to know that the processing at the apparatus 5 in the manufacturing schedule 1 has a clean energy shortage of 3 kW and that the processing at the apparatus 1 in the manufacturing schedule 2 has a clean energy shortage of 3 kW.

The technical significance of being able to know the shortage of clean energy is large. This is because the gap between supply and demand for clean energy at a planned manufacturing time point for a product is able to be known at the time of preparing the production plan. Shortage of supply of clean energy is thereby able to be known beforehand or clean energy, which is more expensive than fossil energy, is able to be purchased minimally.

The request unit 15D illustrated in FIG. 1 is a processing unit that issues a request to another system, such as the production management system 3 or the power transaction system 5. Such issuance of a request is able to be executed automatically in a case where input to the production management system 3 has been set to be permitted by the setting information 13B or in a case where automatic transactions in the power transaction system 5 have been set to be permitted by the setting information 13B. However, even in a case where the input to the production management system 3 or the automatic transactions in the power transaction system 5 has/have been prohibited by the setting information 13B, if operation on a GUI component to permit issuance of requests has been received via the GUI screen illustrated in FIG. 11, for example, a request is able to be issued.

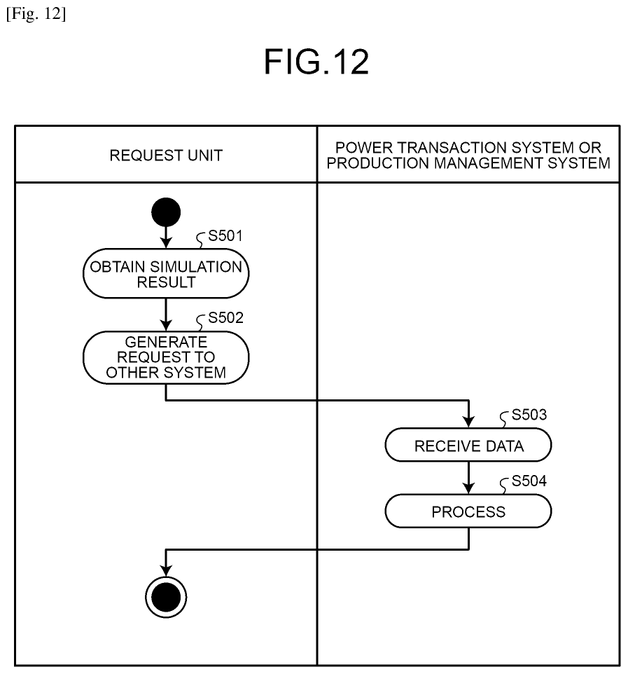

FIG. 12 is a flowchart illustrating steps of a request issuance process. As illustrated in FIG. 12, the request unit 15D obtains results of simulation by the simulation unit 15B (Step S501).

On the basis of the results of simulation obtained at Step S501, the request unit 15D generates a request to another system, such as the production management system 3 or the power transaction system 5 (Step S502) and transmits the request generated, to that other system.

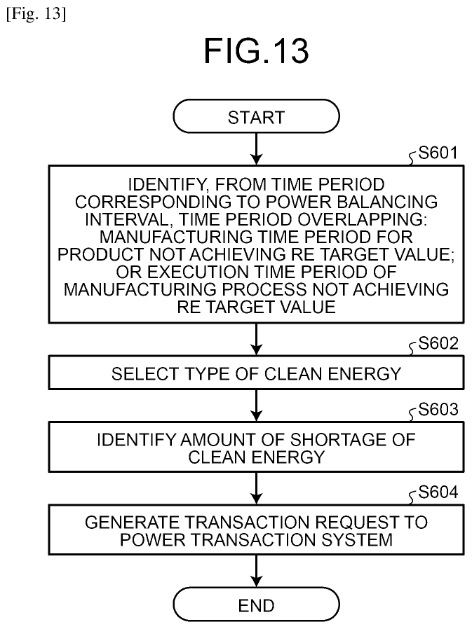

Examples of the generated request to the production management system 3 may include a request for registration of the production plan selected at Step S212 or a request for registration of a production plan specified via a GUI component illustrated in FIG. 10 or FIG. 11. Examples of the generated request to the power transaction system 5 may include a request for purchase of a non-fossil certificate for a shortage of clean energy specified via a GUI component illustrated in FIG. 11. A method of generating a request issued to the power transaction system 5 will be described later by use of FIG. 13.

The other system, such as the production management system 3 or the power transaction system 5, receives the request transmitted by the request unit 15D (Step S503) and executes processing corresponding to the request (Step S504).

FIG. 13 is a flowchart illustrating steps of a request generation process. FIG. 13 illustrates steps of a process of generating a request issued to the power transaction system 5, the process being part of the processing executed at Step S502 illustrated in FIG. 12.

As illustrated in FIG. 13, the request unit 15D identifies, from a time period that has been divided according to a setting of the power balancing interval, a time period overlapping: a manufacturing time period for a specific product that does not achieve an RE target value, for example, RE100; or an interval, in which a manufacturing process is to be executed, the manufacturing process being a process, in which supply of clean energy is going to become insufficient, the manufacturing process being one of manufacturing processes for a specific product (Step S601). At Step S601, the request unit 15D may automatically make a selection or may manually receive a selection from the user terminal 30 via a GUI.

The request unit 15D then selects a supply destination of clean energy that will become insufficient in the time period selected at Step S601 (Step S602). For example, the request unit 15D may automatically select the type of clean energy having the highest degree of priority set in the setting information 13B or receive a selection of the type of clean energy from the user terminal 30 via a GUI.

Subsequently, the request unit 15D identifies an amount of shortage of clean energy in the time period identified at Step S601 (Step S603).

Thereafter, the request unit 15D generates a transaction request including: specification of a frame/frames corresponding to the time period identified at Step S601, the frame/frames being from frames received by the power transaction system 5 as a transaction unit; specification of the type of clean energy selected at Step S602; and specification of an amount of purchase for an environmental value corresponding to the shortage of clean energy identified at Step S603 (Step S604).

Transmitting the transaction request thus generated to the power transaction system 5 enables bidding of a desired type of clean energy for the environmental value of the amount of purchase corresponding to the shortage of clean energy. Even if supply of clean energy is insufficient, purchase of the environmental value thereby enables RE maximization for the specific product. The fact that the user corporation is promoting introduction of renewable energy to its business operations is thus able to be certified. Furthermore, promoting measures for a social goal, such as decarbonization, also leads to improvement of the corporate value.

### One Aspect of Effects

As described above, the information processing apparatus 10 according to the embodiment executes, on the basis of predicted amounts of clean energy supplied in respective time periods and predicted amounts of energy used in respective time periods, a simulation of optimizing a production plan having, planned therein, manufacturing time periods for different products to be produced. Therefore, the information processing apparatus 10 according to the embodiment enables preparation of a production plan that supports RE maximization for products.

### Numerical Values

The particulars described above with respect to the embodiment, for example, the types of energy and the number of power generators, as well as the specific examples, such as the example of display of the simulation and the example of display of the RE levels, are just examples and may be modified. Furthermore, the order of the steps in the flowcharts described with respect to the embodiment may be modified so long as no contradiction is caused by the modification.

### System

The processing steps, control steps, specific names, and information including various data and parameters, which have been described above and illustrated in the drawings may be optionally modified unless particularly stated otherwise. For example, any one or more functional units of the simulation unit 15B, the output unit 15C, and the request unit 15D may be included in different devices.

Furthermore, the components of each apparatus/device in the drawings have been illustrated functionally and/or conceptually, and do not need to be physically configured as illustrated in the drawings. That is, specific modes of separation and integration of each apparatus/device are not limited to those illustrated in the drawings. That is, all or part of each apparatus/device may be configured by functional or physical separation or integration thereof in any units according to various loads and/or use situations. Each configuration may also be a physical configuration.

Furthermore, all or any part of the processing functions performed in each apparatus/device may be implemented by a central processing unit (CPU) and a program analyzed and executed by the CPU, or may be implemented as hardware by wired logic.

### Hardware

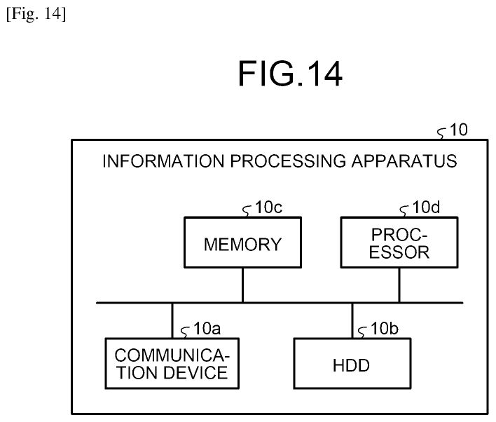

An example of a hardware configuration of a computer described with respect to the embodiment will be described next. FIG. 14 is a diagram illustrating the example of the hardware configuration. As illustrated in FIG. 14, the information processing apparatus 10 has a communication device 10a, a hard disk drive (HDD) 10b, a memory 10c, and a processor 10d. Furthermore, these units illustrated in FIG. 14 are connected to one another via a bus, for example.

The communication device 10a is a network interface card, for example, and performs communication with another server. The HDD 10b stores a program that causes the functions illustrated in FIG. 1 to operate and a DB, for example.

The processor 10d causes a process to be operated, the process executing the functions described by reference to FIG. 1, for example, by reading, from the HDD 10b, for example, the program that executes processing similar to that by the processing units illustrated in FIG. 1, and loading the program into the memory 10c. For example, this process executes functions similar to those of the processing units that the information processing apparatus 10 has. Specifically, the processor 10d reads the program having functions similar to those of the reception unit 15A, the simulation unit 15B, the output unit 15C, and the request unit 15D, from the HDD 10b, for example. The processor 10d then executes a process that executes processing similar to that by the reception unit 15A, the simulation unit 15B, the output unit 15C, and the request unit 15D, for example.

As described above, the information processing apparatus 10 operates as an information processing apparatus that executes a production plan preparation method, by reading and executing the program. Furthermore, the information processing apparatus 10 may implement functions similar to those according to the above described embodiment by reading the program from a recording medium by means of a medium reading device, and executing the program read. The program referred to herein is not limited to being executed by the information processing apparatus 10. For example, the present invention may be similarly applied to a case where another computer or server executes the program, or a case where the computer and the server execute the program in corporation with each other.

The program may be distributed via a network, such as the Internet. Furthermore, the program may be recorded in any recording medium and executed by being read by a computer from the recording medium. For example, the recording medium may be implemented by a hard disk, a flexible disk (FD), a CD-ROM, a magneto-optical disk (MO), or a digital versatile disc (DVD).

### Others

The following are some examples of a combination of technical features disclosed herein.

(1)

An information processing apparatus comprising:
a first reception unit configured to receive a predicted amount of clean energy supplied;
a second reception unit configured to receive a predicted amount of energy used; and
a simulation unit configured to execute, on the basis of the predicted amount of clean energy supplied and the predicted amount of energy used, a simulation of optimizing a production plan, having planned therein, a manufacturing time period of each of products to be produced.
   (2)

The information processing apparatus according to (1), wherein the simulation unit optimizes the production plan by maximizing or minimizing an objective function including a difference or ratio between the predicted amount of clean energy supplied and the predicted amount of energy used.

(3)

The information processing apparatus according to (1) or (2), further comprising:
a third reception unit configured to receive a setting of a degree of priority for an allocated target where the predicted amount of clean energy supplied is to be allocated, wherein
the simulation unit determines, by comparing the predicted amount of clean energy supplied with the predicted amount of energy used at the allocated target included in the production plan obtained as a result of the simulation, an amount of clean energy to be allocated to the allocated target on the basis of the degree of priority.
   (4)

The information processing apparatus according to (3), further comprising a request unit configured to issue a request to a power transaction system enabling buying and selling transactions of environmental values separated from electricity of non-fossil energy after power generation, the request being for purchase of an environmental value corresponding to a shortage that the amount of clean energy to be allocated has in relation to the predicted amount of energy used.

(5)

The information processing apparatus according to (3) or (4), wherein
the first reception unit receives the predicted amount of clean energy supplied, for each of types of clean energy,
the third reception unit receives the setting of the degree of priority for each of the types and each of time periods, and
the simulation unit determines the amount of clean energy to be allocated, for each of the types and each of the time periods.
   (6)

A production plan preparation method carried out by a computer, comprising:
receiving a predicted amount of clean energy supplied;
receiving a predicted amount of energy used; and
executing, on the basis of the predicted amount of clean energy supplied and the predicted amount of energy used, a simulation of optimizing a production plan, having planned therein, a manufacturing time period of each of products to be produced.
   (7)

A production plan preparation program that causes a computer to execute a process comprising:
receiving a predicted amount of clean energy supplied;
receiving a predicted amount of energy used; and
executing, on the basis of the predicted amount of clean energy supplied and the predicted amount of energy used, a simulation of optimizing a production plan, having planned therein, a manufacturing time period of each of products to be produced.

### REFERENCE SIGNS LIST

1 Production plan preparation system
3 Production management system
5 Power transaction system
7 Various devices
10 Information processing apparatus
11 Communication control unit
13 Storage unit
13A Predicted amount of supply
13B Setting information
13C Predicted amount of use
13D Production specification information
15 Control unit
15A Reception unit
15B Simulation unit
15C Output unit
15D Request unit
30 User terminal

1. An information processing apparatus comprising:
a processor configured to:
receive a predicted amount of clean energy supplied;
receive a predicted amount of energy used; and
execute, on the basis of the predicted amount of clean energy supplied and the predicted amount of energy used, a simulation of optimizing a production plan, having planned therein, a manufacturing time period of each of products to be produced.

2. The information processing apparatus according to claim 1, wherein the processor is further configured to optimize the production plan by maximizing or minimizing an objective function including a difference or ratio between the predicted amount of clean energy supplied and the predicted amount of energy used.

3. The information processing apparatus according to claim 1 wherein the processor is further configured to:
receive a setting of a degree of priority for an allocated target where the predicted amount of clean energy supplied is to be allocated; and
determine, by comparing the predicted amount of clean energy supplied with the predicted amount of energy used at the allocated target included in the production plan obtained as a result of the simulation, an amount of clean energy to be allocated to the allocated target on the basis of the degree of priority.

4. The information processing apparatus according to claim 3, wherein the processor is further configured to issue a request to a power transaction system enabling buying and selling transactions of environmental values separated from electricity of non-fossil energy after power generation, the request being for purchase of an environmental value corresponding to a shortage that the amount of clean energy to be allocated has in relation to the predicted amount of energy used.

5. The information processing apparatus according to claim 3, wherein the processor is further configured to:
receive the predicted amount of clean energy supplied, for each of types of clean energy;
receive the setting of the degree of priority for each of the types and each of time periods; and
determine the amount of clean energy to be allocated, for each of the types and each of the time periods.

6. A production plan preparation method comprising:
receiving a predicted amount of clean energy supplied;
receiving a predicted amount of energy used; and
executing, on the basis of the predicted amount of clean energy supplied and the predicted amount of energy used, a simulation of optimizing a production plan, having planned therein, a manufacturing time period of each of products to be produced, using a processor.

7. A non-transitory computer-readable recording medium having stored therein a production plan preparation program that causes a computer to execute a process comprising:
receiving a predicted amount of clean energy supplied;
receiving a predicted amount of energy used; and
executing, on the basis of the predicted amount of clean energy supplied and the predicted amount of energy used, a simulation of optimizing a production plan, having planned therein, a manufacturing time period of each of products to be produced.
